(19) United States
(12) Patent Application Publication
(10) Pub. No.: US 2014/0297685 A1
(43) Pub. Date: Oct. 2, 2014

(54) DATA MANAGEMENT APPARATUS, DATA MANAGEMENT METHOD AND DATA MANAGEMENT PROGRAM

(71) Applicant: Akira Nojima, Minato-ku (JP)

(72) Inventor: Akira Nojima, Minato-ku (JP)

(73) Assignee: TOSHIBA MITSUBISHI-ELECTRIC INDUSTRIAL SYSTEMS CORPORATION, Minato-ku, Tokyo (JP)

(21) Appl. No.: 14/356,489

(22) PCT Filed: Jun. 26, 2012
(86) PCT No.: PCT/JP2012/066197

§ 371 Date: May 6, 2014

(51) Int. Cl. G06F 17/30

(52) U.S. Cl. CPC G06F 17/30424; G06F 17/30312
USPC 707/769

(57) ABSTRACT

An apparatus includes: a first range data storage section 21 for storing as first range data upper and lower limit values of process data, and a first reference point of time, while associating the upper and lower limit values with the first reference point of time; a second range data storage section 22 for storing as second range data upper and lower limit values of process data acquired in each second period, and a second reference point of time, while associating the upper and lower limit values with the second reference point of time; a sampling data storage section 113b for storing as sampling data process data including a chronological change, and an elapsed time from a reference point of time, while associating the process data with the elapsed time; and a storage controller 111a for storing the first range data, the second range data and the sampling data.

### TECHNICAL FIELD

The present invention relates to a data management apparatus, a data storage method and a data storage program for storing process data acquired from a monitoring target in a plant.

### BACKGROUND ART

As an apparatus configured to collect various data from a monitoring target in a plant, Patent Document 1, for example, has proposed a data collection apparatus which collects binary data on control information outputted by a control apparatus to an iron and steel plant; collects binary data on event information on the iron and steel plant to be controlled by use of the control information outputted by the control apparatus; adds a common key to the binary data on the control information and the binary data on the event information which are collected at the same time; and accumulates the binary data on the control information with the added common key while accumulating the binary data on the event information with the added common key.

### PRIOR ART DOCUMENT

### Patent Document

Patent Document 1: Japanese Patent Application Publication No. 2010-271850

### SUMMARY OF THE INVENTION

### Problem to be Solved by the Invention

When, however, the data collection apparatus described in Patent Document 1 is applied to a large-scale plant control system, a problem arises that a large-capacity storage medium is needed to store process data.

The present invention has been carried out with the foregoing problem taken into consideration. The present invention aims at providing a data management apparatus, a data management method and a data management program which are capable of: storing a large amount of process data in a relatively small storage area; and searching the stored process data at high speed.

### Means for Solving the Problems

For the purpose of achieving the foregoing object, a first feature of a data management apparatus of the present invention is that the data management apparatus includes: a first range data storage section configured to store, as first range data, an upper limit value and a lower limit value of process data acquired from a monitoring target in each first period from a reference point of time, and a first reference point of time which is a start time for the first period, while associating the upper and lower limit values with the first reference point of time; a second range data storage section configured to store, as second range data, an upper limit value and a lower limit value of the process data acquired from the monitoring target in each second period from the reference point of time, the second period being shorter than the first period, and a second reference point of time which is a start time for the second period, while associating the upper and lower limit values with the second reference point of time; a sampling data storage section configured to store, as sampling data, the process data acquired from the monitoring target and including a chronological change, and an elapsed time from the reference point of time, while associating the process data with the elapsed time; and a storage controller configured, on the basis of the process data acquired from the monitoring target, to generate the first range data and to store the generated first range data into the first range data storage section in each first period, to generate the second range data and to store the generated second range data into the second range data storage section in each second period, and to generate the sampling data and to store the generated sampling data into the sampling data storage section in each second period.

A second feature of the data management apparatus of the present invention is that the data management apparatus further includes: a first judgment section configured, when a search for the process data is requested, to judge whether or not process data satisfying a search condition in the search request is included in a range from the upper limit value to the lower limit value of the first range data; a second judgment section configured to judge whether or not the process data satisfying the search condition in the search request is included in a range from the upper limit value to the lower limit value of the second range data if the first judgment section judges that the process data is included in the range from the upper limit value to the lower limit value of the first range data; and an extractor configured to extract the sampling data including the process data satisfying the search condition in the search request from the sampling data storage section if the second judgment section judges that the process data is included in the range from the upper limit value to the lower limit value of the second range data.

Meanwhile, a first feature of a data management method of the present invention is that the data management method includes: a first range data storage step of storing, as first range data, an upper limit value and a lower limit value of process data acquired from a monitoring target in each first period from a reference point of time, and a first reference point of time which is a start time for the first period, into a first range data storage section while associating the upper and lower limit values with the first reference point of time; a second range data storage step of storing, as second range data, an upper limit value and a lower limit value of the process data acquired from the monitoring target in each second period from the reference point of time, the second period being shorter than the first period, and a second reference point of time which is a start time for the second period, into a second range data storage section while associating the upper and lower limit values with the second reference point of time; and a sampling data storage step of storing, as sampling data, the process data acquired from the monitoring target and including a chronological change, and an elapsed time from the reference point of time, into a sampling data storage section while associating the process data with the elapsed time.

A second feature of the data management method of the present invention is that the data management method further includes: a first judgment step of, when a search for the process data is requested, judging whether or not process data satisfying a search condition in the search request is included in a range from the upper limit value to the lower limit value of the first range data; a second judgment step of judging whether or not the process data satisfying the search condition in the search request is included in a range from the upper limit value to the lower limit value of the second range data if it is judged in the first judgment step that the process data is included in the range from the upper limit value to the lower limit value of the first range data; and an extraction step of extracting the sampling data including the process data satisfying the search condition in the search request from the sampling data storage section if it is judged in the second judgment step that the process data is included in the range from the upper limit value to the lower limit value of the second range data.

Meanwhile, a first feature of a data management program of the present invention is that the data management program causes a computer to execute: a first range data storage step of storing, as first range data, an upper limit value and a lower limit value of process data acquired from a monitoring target in each first period from a reference point of time, and a first reference point of time which is a start time for the first period, into a first range data storage section while associating the upper and lower limit values with the first reference point of time; a second range data storage step of storing, as second range data, an upper limit value and a lower limit value of the process data acquired from the monitoring target in each second period from the reference point of time, the second period being shorter than the first period, and a second reference point of time which is a start time for the second period, into a second range data storage section while associating the upper and lower limit values with the second reference point of time; and a sampling data storage step of storing, as sampling data, the process data acquired from the monitoring target and including a chronological change, and an elapsed time from the reference point of time, into a sampling data storage section while associating the process data with the elapsed time.

A second feature of the data management program of the present invention is that the data management program causes the computer to further execute: a first judgment step of, when a search for the process data is requested, judging whether or not process data satisfying a search condition in the search request is included in a range from the upper limit value to the lower limit value of the first range data; a second judgment step of judging whether or not the process data satisfying the search condition in the search request is included in a range from the upper limit value to the lower limit value of the second range data if it is judged in the first judgment step that the process data is included in the range from the upper limit value to the lower limit value of the first range data; and an extraction step of extracting the sampling data including the process data satisfying the search condition in the search request from the sampling data storage section if it is judged in the second judgment step that the process data is included in the range from the upper limit value to the lower limit value of the second range data.

### Effects of the Invention

The data management apparatus, the data management method and the data management program of the present invention are capable of: storing a large amount of process data in a relatively small storage area; and searching the stored process data at high speed.

### BRIEF DESCRIPTION OF THE DRAWINGS

FIG. 1 is a diagram showing an example of a configuration of an online data management system including a data management apparatus of a first embodiment of the present invention.

FIG. 2 is a diagram schematically showing a data structure in a storage unit included in the data management apparatus of the first embodiment of the present invention.

FIG. 3 is a diagram showing an example of a 10-minute range data location file stored in a range data storage section in the storage unit included in the data management apparatus of the first embodiment of the present invention.

FIG. 4 is a diagram showing an example of a 10-minute range data file stored in the range data storage section in the storage unit included in the data management apparatus of the first embodiment of the present invention.

FIG. 5 is a diagram showing an example of block data on the 10-minute range data file stored in the range data storage section in the storage unit included in the data management apparatus of the first embodiment of the present invention.

FIG. 6 is a diagram explaining a relationship between the 10-minute range data location file and the 10-minute range data file which are stored in the range data storage section in the storage unit included in the data management apparatus 1 of the first embodiment of the present invention.

FIG. 7 is a diagram showing an example of a 1-minute range data location file stored in the range data storage section in the storage unit included in the data management apparatus of the first embodiment of the present invention.

FIG. 8 is a diagram showing an example of a 1-minute range data file stored in the range data storage section in the storage unit included in the data management apparatus of the first embodiment of the present invention.

FIG. 9 is a diagram showing an example of block data on the 1-minute range data file stored in the range data storage section in the storage unit included in the data management apparatus of the first embodiment of the present invention.

FIG. 10 is a diagram explaining a relationship between the 1-minute range data location file and the 1-minute range data file which are stored in the range data storage section in the storage unit included in the data management apparatus of the first embodiment of the present invention.

FIG. 11 is a diagram showing an example of a sampling data file stored in a sampling data storage section in the storage unit included in the data management apparatus of the first embodiment of the present invention.

FIG. 12 is a diagram showing an example of a minute-based data stored in the sampling data storage section in the storage unit included in the data management apparatus of the first embodiment of the present invention.

FIG. 13 is a flowchart showing procedures of search processing by the data management apparatus of the first embodiment of the present invention.

FIG. 14 is a diagram explaining an example of how the data management apparatus of the first embodiment of the present invention performs the search processing on one item.

FIG. 15A is a diagram explaining an example of how the data management apparatus of the first embodiment of the present invention performs the search processing on two items.

FIG. 15B is a diagram explaining an example of how the data management apparatus of the first embodiment of the present invention performs the search processing on two items.

### MODES FOR CARRYING OUT THE INVENTION

### First Embodiment

Descriptions will be hereinbelow provided for a first embodiment respectively of a data management apparatus, a data management method and a data management program of the first embodiment of the present invention.

### <Explanation of Configuration)

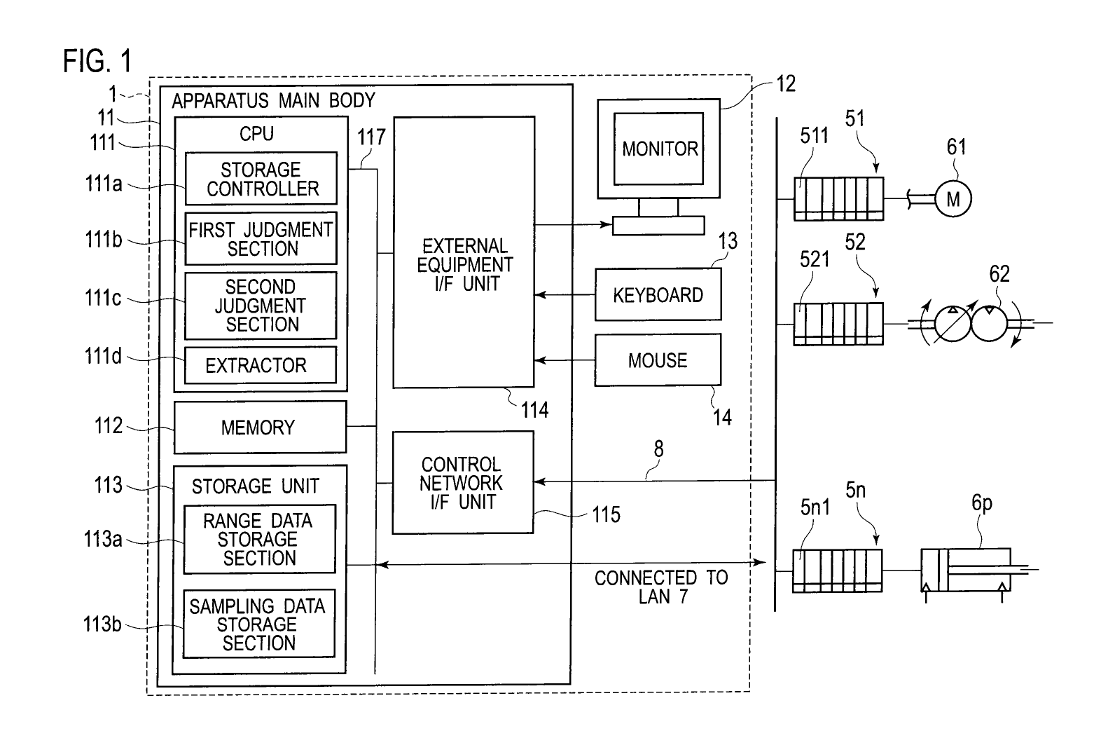

FIG. 1 is a diagram showing an example of a configuration of an online data management system including a data management apparatus of a first embodiment of the present invention.

This online data management system manages, for example, process data acquired from various monitoring targets in plant systems such as: a hot rolling plant system for making a heated slab of iron, stainless steel or aluminum into a hot-rolled coil with a thickness of several millimeters to ten something millimeters by rolling the slab in a rolling mill; and a process line plant system for performing acid pickling, annealing, plating, coating, cutting and the like on a coil produced by a hot rolling plant or a cold rolling plant for the purpose of making final products out of the coil.

In FIG. 1, the online data management system includes a data management apparatus 1 of the first embodiment of the present invention and controllers 51 to 5n (n: an integer) which are connected together. Examples of the controllers 51 to 5n include programmable logic controllers (PLC). The online data management system is a system configured to monitor the operating conditions, control conditions and the like of monitoring targets 61 to 6p (p: an integer) by use of process data acquired by the controllers 51 to 5n. Examples of the monitoring targets 61 to 6p include: a rolling mill; a pressing machine; and a motor, pistons and the like for driving such machines.

In this respect, the data management apparatus 1 and the controllers 51 to 5n are connected together through a control network 8, for example.

In addition, the data management apparatus 1 of the first embodiment of the present invention is formed from a computer apparatus in which a monitor (display) 12, a keyboard 13, a mouse 14 and the like are connected to an apparatus main body 11. The data management apparatus 1 is configured to store sampling data inclusive of multiple numerical data which are acquired from the controllers 51 to 5n, and to display the sampling data on the monitor 12 in a normal mode.

Descriptions will be later provided for things such as: a configuration and operations of the data management apparatus 1 of the first embodiment of the present invention; and configurations of the process data.

The controllers 51 to 5n are configured to control the operations of the various monitoring targets 61 to 6p such as a motor, a heating apparatus and a hydraulic apparatus on the basis of programs. The controllers 51 to 5n are configured to acquire the process data, inclusive of the numerical data, which are detected from the various monitoring targets 61 to 6p at predetermined sampling intervals in time series, through the their respective I/O (input/output) units 511 to 5n1.

The data management apparatus 1 is formed from the computer apparatus in which the monitor (display) 12, the keyboard 13, the mouse 14 and the like are connected to its apparatus main body 11.

As shown in FIG. 1, the apparatus main body 11 includes a CPU 111, a memory 112, a storage unit 113 such as a HDD or a large-capacity memory, an external equipment interface (hereinafter abbreviated to I/F) unit 114, a control network I/F unit 115, and the like which are connected together through an internal bus 117.

The CPU 111 functionally includes a storage controller 111a, a first judgment section 111b, a second judgment section 111c and an extractor 111d by executing data management programs among various application programs stored in the storage unit 113.

On the basis of the process data acquired from each of the controllers 51 to 5n, the storage controller 111a generates below-described first range data and stores the generated first range data into a first range data storage section in each first period; generates below-described second range data and stores the generated second range data into a second range data storage section in each second period; and generates below-described sampling data and stores the generated sampling data into a sampling data storage section 113b in each second period.

When the search for process data is requested, the first judgment section 111b judges whether or not the process data satisfying search conditions in the search request are included in a range from an upper limit value to a lower limit value of the first range data.

If the first judgment section 111b judges that the process data are included in the range from the upper limit value to the lower limit value of the first range data, the second judgment section 111c judges whether or not the process data satisfying the search conditions in the search request are included in a range from an upper limit value to a lower limit value of the second range data.

If the second judgment section 111c judges that the process data are included in the range from the upper limit value and the lower limit value of the second range data, the extractor 111d extracts sampling data, which include the process data satisfying the search conditions in the search request, from the sampling data storage section.

The memory 112 is used as an operation area or the like which performs temporary storage of data, expansion of the data, and the like when the CPU 111 executes the various application programs.

The storage unit 113 includes the range data storage section 113a and the sampling data storage section 113b.

In the first embodiment, the range data storage section 113a and the sampling data storage section 113b are provided in the single storage unit 113. However, it is a matter of course that the range data storage section 113a and the sampling data storage section 113b may be formed as separate storage units.

The control network I/F unit 115 is an interface configured to connect a control network 8 and the apparatus main body 11 to each other.

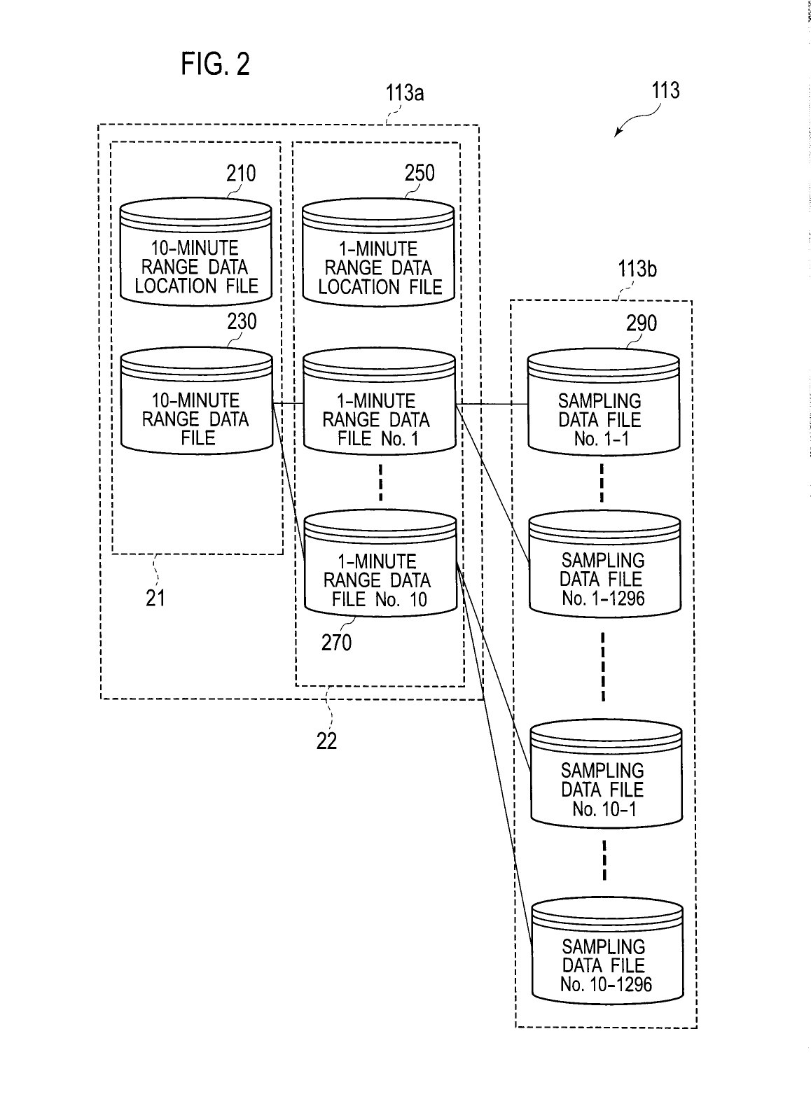

FIG. 2 is a diagram schematically showing a data structure in the storage unit 113 included in the data management apparatus 1 of the first embodiment of the present invention.

As shown in FIG. 2, the storage unit 113 includes the range data storage section 113a and the sampling data storage section 113b as its storage areas.

The range data storage section 113a includes a first range data storage section 21 and a second range storage section 22.

In each 10 minutes (first period) from sampling start time (a reference point of time), the first range data storage section 21 stores as the first range data the upper and lower limit values of the process data acquired from each of the controllers 51 to 5n as well as a first reference point of time which is the start time for the first period while associating the upper and lower limit values with the first reference point of time. To put it specifically, the first range data storage section 21 stores a 10-minute range data location file 210 and 10-minute range data files 230.

In each one minute (second period) from the sampling start time (the reference point of time), the second range data storage section 22 stores as the second range data the upper and lower limit values of the process data acquired from each of the controllers 51 to 5n, as well as a second reference point of time which is the start time for the second period while associating the upper and lower limit values with the second reference point of time. To put it specifically, the second range data storage section 22 stores a 1-minute range data location file 250 and 1-minute range data files 270.

The sampling data storage section 113b stores as the sampling data the process data acquired from each of the controllers 51 to 5n and including a chronological change as well as an elapsed time from the sampling start time (the reference point of time) while associating the process data with the elapsed time. To put it specifically, the sampling data storage section 113b stores sampling data files 290.

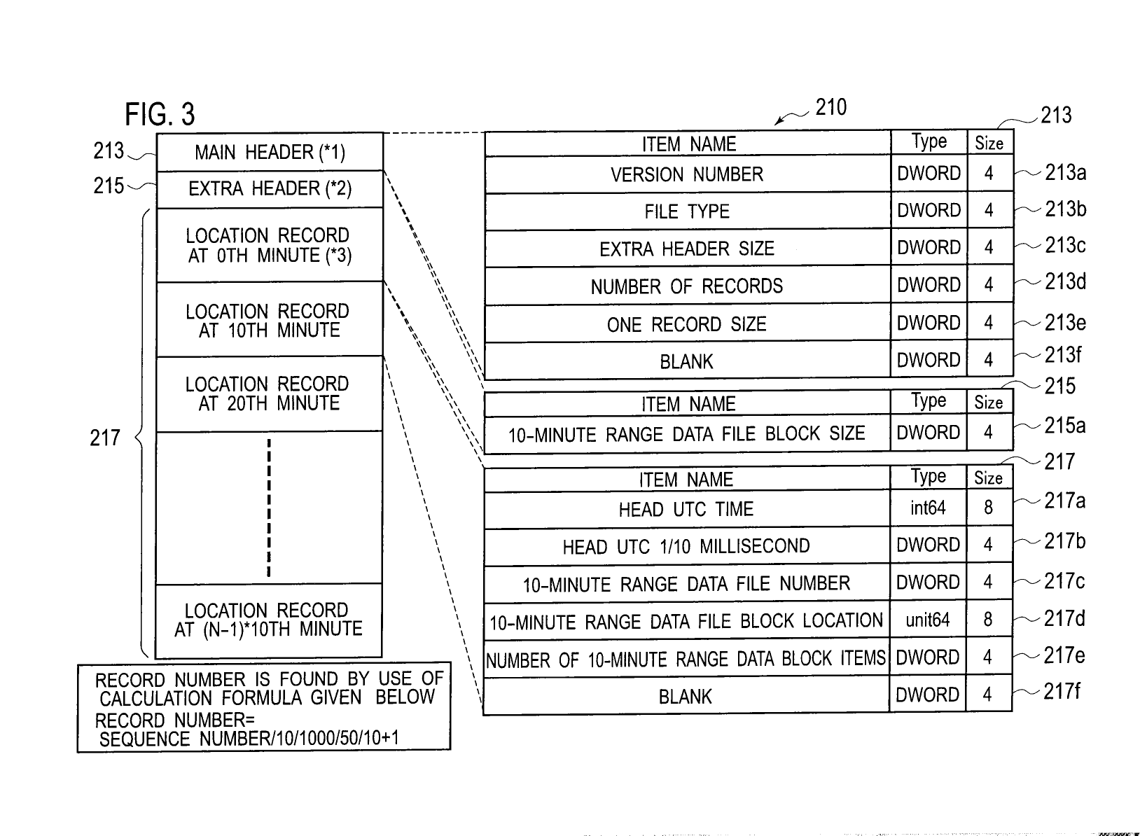

FIG. 3 is a diagram showing an example of the 10-minute range data location file 210 stored in the range data storage section 113a in the storage unit 113 included in the data management apparatus 1 of the first embodiment of the present invention.

As shown in FIG. 3, the 10-minute range data location file 210 includes: a main header 213 including fixed information on the 10-minute range data location file; an extra header 215 including extended information on the 10-minute range data location file; and location records 217 each including location information on the 10-minute range data location file.

The main header 213 includes: a version number 213a which is a fixed value; a file type 213b indicating the file type of the 10-minute range data location file 210; an extra header size 213c indicating the size of the extra header 215; the number of records 213d indicating the number of the location records 217; a record size 213e indicating the size of each location record 217; and a blank 213f for reserving a spare area for data storage.

The extra header 215 includes a 10-minute range data file block size 215a indicating the size of a block in which the 10-minute range data file 230 is stored.

Each location record 217 includes: a head UTC time 217a indicating the time (the first reference point of time) corresponding to the head of the 10-minute range data file 230; a head UTC 1/10 millisecond 217b which is time data indicating the head UTC time 217a in the order of 1/10 millisecond; a 10-minute range data file number 217c indicating the file number of the 10-minute range data file; a 10-minute range data file block location 217d indicating a location of the block from the head where the 10-minute range data file 230 is stored; the number of 10-minute range data block items 217e indicating the number of items in the block data on the 10-minute range data file 230; and a blank 217f for reserving a spare area for the data storage.

Since as described above, each location record 217 stores the various 10-minute (first period)-based data acquired from each of the controllers 51 to 5n in each 10 minutes (first period) from the sampling start time (the reference point of time), the head UTC time 217a included in the location record 217 at the head becomes the sampling start time (the reference point of time).

It should be noted that, if represented with accuracy in the order of 1/10 millisecond by use of the head UTC time 217a and the head UTC 1/10 millisecond 217b, the time (the first reference point of time) corresponding to the head of the 10-minute range data file 230 may be used as the first reference point of time. Alternatively, only the head UTC time 217a may be used as the time (the first reference point of time) corresponding to the head of the 10-minute range data file 230.

In addition, location record numbers are numbers assigned to the location records 217, respectively, in the 10-minute range data file 230, and are calculated on the basis of Formula 1 given below. On the basis of the location record numbers, the various data, inclusive of the head UTC time 217a, are stored.

Location Record Number=Sequence Number/10/1000/60/10+1 (Formula 1)

where the sequence number is a serial number to be counted up each time the process data are collected by the controllers 51 to 5n at the predetermined sampling cycles beginning at the sampling start time (the reference point of time). In this respect, the sampling cycles in which the process data are acquired from the controllers 51 to 5n are determined at 0.1 (ms), for example.

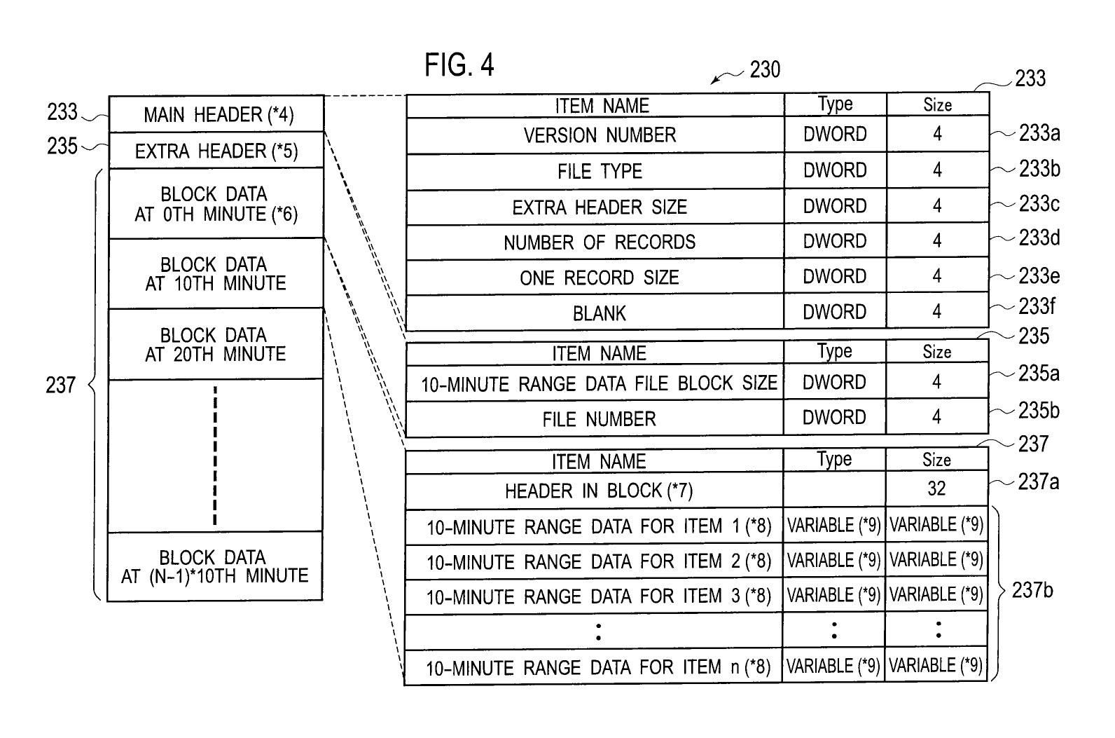

FIG. 4 is a diagram showing an example of the 10-minute range data file 230 stored in the range data storage section 113a in the storage unit 113 included in the data management apparatus 1 of the first embodiment of the present invention.

As shown in FIG. 4, the 10-minute range data file 230 includes: a main header 233 including fixed information on the 10-minute range data file; an extra header 235 including extended information on the 10-minute range data file; and block data 237 each including the upper and lower limit values of process data in the corresponding 10-minute range, and the like.

The main header 233 includes: a version number 233a which is a fixed value; a file type 233b indicating the file type of the 10-minute range data file 230; an extra header size 233c indicating the size of the extra header 235; the number of records 233d indicating the number of the location records 217; a record size 233e indicating the size of each location record 217; and a blank 233f for reserving an area for alignment.

The extra header 235 includes: a 10-minute range data file block size 235a indicating the size of a block in which the 10-minute range data file 230 is stored; and a file number 235b indicating the file number of the 10-minute range data file 230.

The block data 237 each includes: a header-in-block 237a including fixed information on the block data 237; and 10-minute range data 237b each including the upper and lower limit values of process data in the corresponding 10-minute range for each item number, and the like. In this respect, the item numbers are, for example, uniquely-assigned numbers for identifying items acquired by the controllers 51 to 5n, such as pressing pressures of the rolling mills which are the monitoring targets 61 to 6p.

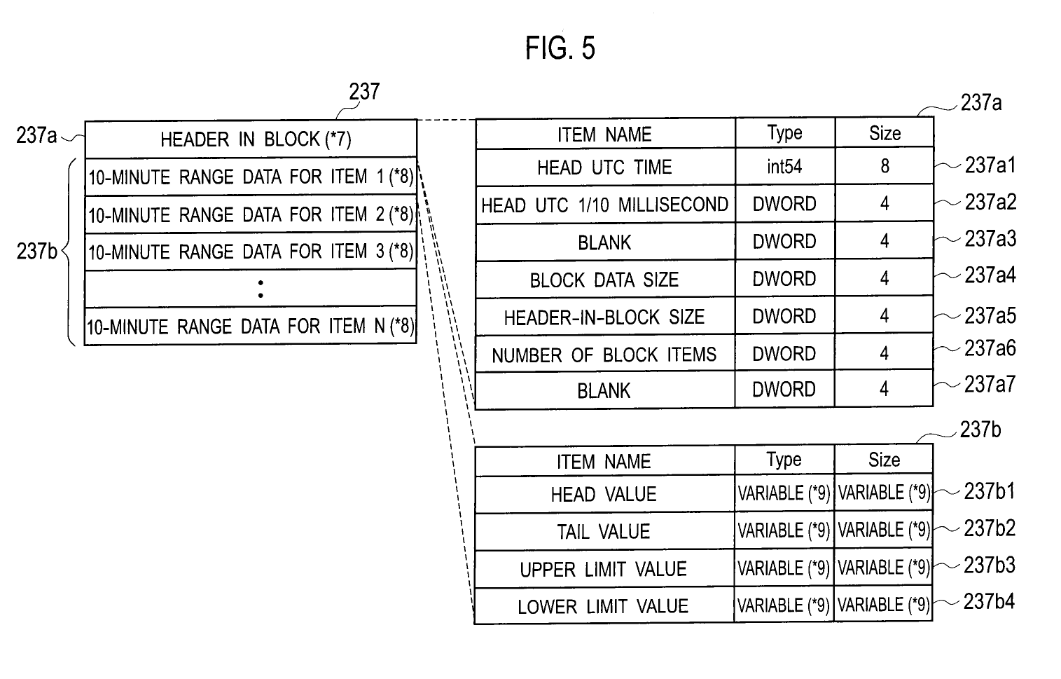

FIG. 5 is a diagram showing an example of block data 237 on a 10-minute range data file 230 stored in the range data storage section 113a in the storage unit 113 included in the data management apparatus 1 of the first embodiment of the present invention.

As shown in FIG. 5, the header in block 237a includes: a head UTC time 237a1 indicating the time (the first reference point of time) corresponding to the head of the block data 237; a head UTC 1/10 millisecond 237a2 which is time data indicating the head UTC time 237a1 in the order of 1/10 millisecond; a blank 237a3 for reserving a spare area for data storage; a block data size 237a4 indicating the size of the block data 237 excluding the size of the header-in-block 237a; a header-in-block size 237a5 indicating the size of the header-in-block 237a; the number of block items 237a6 indicating the number of items in the 10-minute range data 237b in the block data 237; and a blank 237a7 for reserving a spare area for data storage.

In addition, for each item number, the 10-minute range data 237b include: a head value 237b1 indicating the process data at the head of the 10-minute range data 237b; a tail value 237b2 indicating the process data at the tail of the 10-minute range data 237b; an upper limit value 237b3 indicating the upper limit value of the process data in a range corresponding to the 10-minute range data 237b; and a lower limit value 237b4 indicating the lower limit value of the process data in the range corresponding to the 10-minute range data 237b.

Since as described above, the block data 237 store the various 10-minute (first period)-based data acquired from each of the controllers 51 to 5n in each 10 minutes (first period) from the sampling start time (the reference point of time), the head UTC time 217a1 included in the block data 237 at the head becomes the sampling start time (the reference point of time).

It should be noted that, if represented with accuracy in the order of 1/10 millisecond by use of the head UTC time 237a1 and the head UTC 1/10 millisecond 237b2, the time (the first reference point of time) corresponding to the head of the 10-minute range data file 230 may be used as the first reference point of time. Alternatively, only the head UTC time 237a1 may be used as the time (the first reference point of time) corresponding to the head of the 10-minute range data file 230.

As described above, in each 10 minutes (first period) from the sampling start time (the reference point of time), the range data storage section 113a stores the upper and lower limit values of the 10-minute (first period)-based process data acquired from each of the controllers 51 to 5n as well as the first reference point of time which is the start time for the minutes (the first period), as the 10-minute range data file 230 (the first range data), while associating the upper and lower limit values with the first reference point of time.

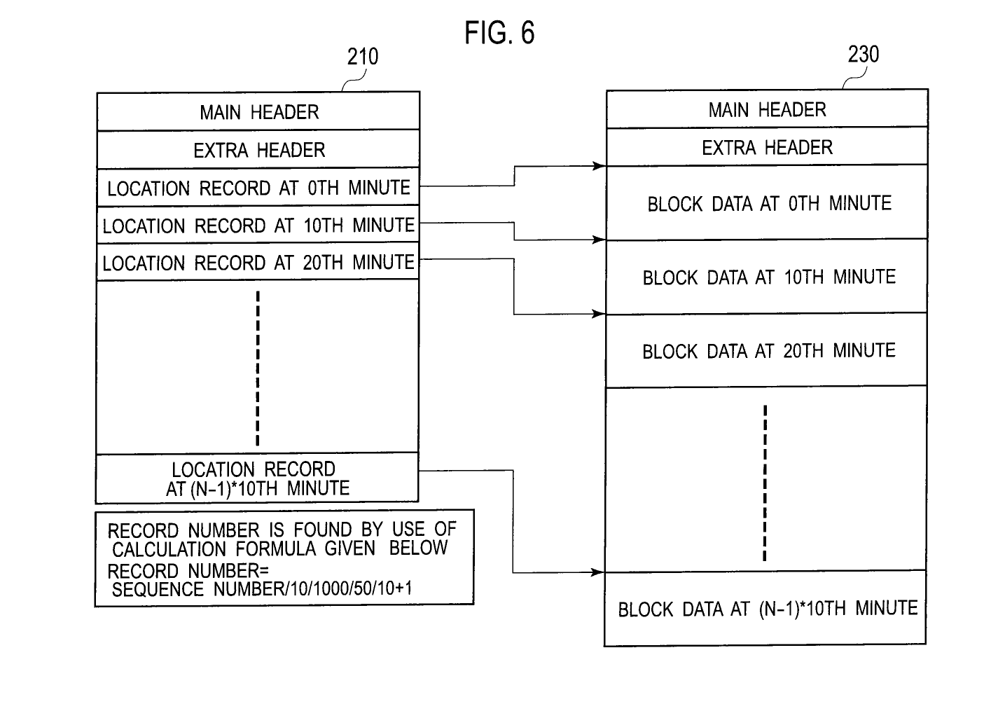

FIG. 6 is a diagram explaining a relationship between the 10-minute range data location file 210 and the 10-minute range data file 230 which are stored in the range data storage section 113a in the storage unit 113 included in the data management apparatus 1 of the first embodiment of the present invention.

As shown in FIG. 6, on the basis of the data stored in the 10-minute range data location file 210, the storage controller 111a is capable of storing data into the 10-minute range data file 230.

To put it specifically, as described above, the storage controller 111a in the CPU 111 calculates the location record numbers to be assigned to the location records 217 in the 10-minute range data file 230 by use of Formula 1. Thereby, on the basis of the calculated location record numbers, the storage controller 111a is capable of storing the block data 237 into the 10-minute range data file 230.

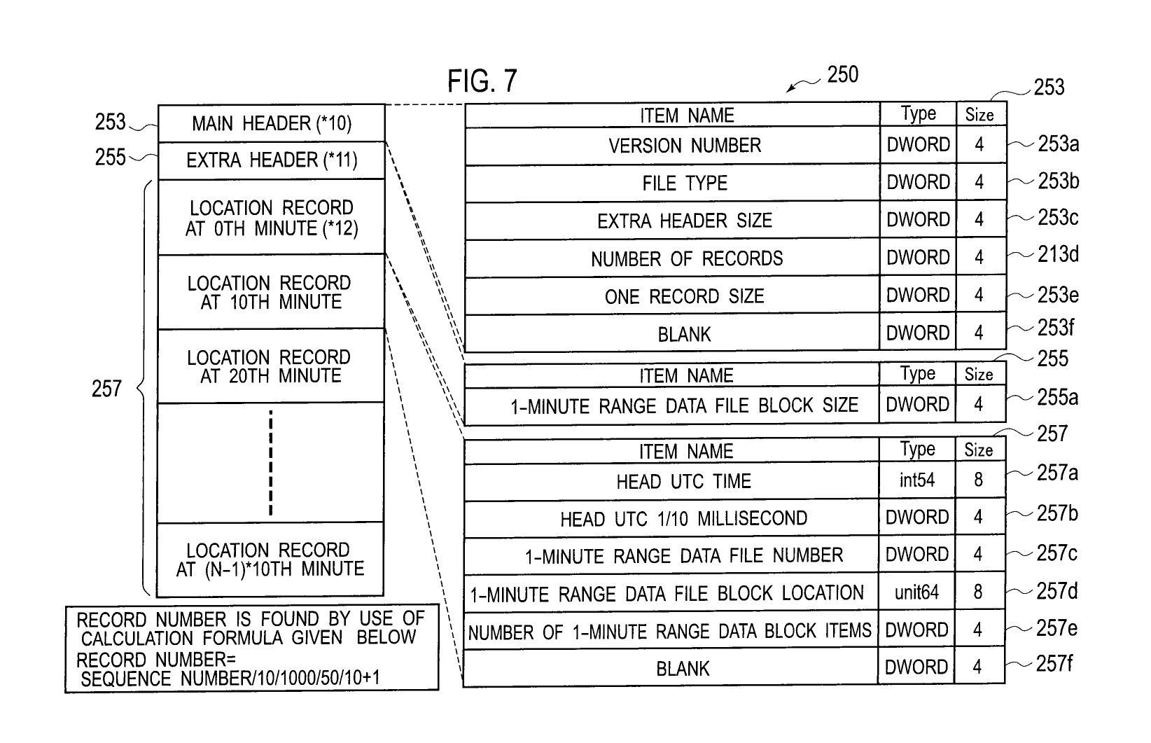

FIG. 7 is a diagram showing an example of a 1-minute range data location file 250 stored in the range data storage section 113a in the storage unit 113 included in the data management apparatus 1 of the first embodiment of the present invention.

As shown in FIG. 7, the 1-minute range data location file 250 includes: a main header 253 including fixed information on the 1-minute range data location file; an extra header 255 including extended information on the 1-minute range data location file 250; and location records 257 each including location information on the 1-minute range data location file 250.

The main header 253 includes: a version number 253a which is a fixed value; a file type 253b indicating the file type of the 1-minute range data location file 250; an extra header size 253c indicating the size of the extra header 255; the number of records 253d indicating the number of the location records 257; a record size 253e indicating the size of each location record 257; and a blank 253f for reserving a spare area for data storage.

The extra header 255 includes a 1-minute range data file block size 255a indicating the size of a block in which the 1-minute range data file is stored.

Each location record 257 includes: a head UTC time 257a indicating the time (the second reference point of time) corresponding to the head of the 1-minute range data file; a head UTC 1/10 millisecond 257b which is time data indicating the head UTC time 257a in the order of 1/10 millisecond; a 1-minute range data file number 257c indicating the file number of the 1-minute range data file; a 1-minute range data file block location 257d indicating a location of the block from the head where the 1-minute range data file is stored; the number of 1-minute range data block items 257e indicating the number of items in the block data on the 1-minute range data file; and a blank 257f for reserving a spare area for the data storage.

Since as described above, each location record 257 stores the various 1-minute (second period)-based data acquired from each of the controllers 51 to 5n in each minute (second period) from the sampling start time (the reference point of time), the head UTC time 257a included in the location record 257 at the head becomes the sampling start time (the reference point of time).

In this respect, it should be noted that the location record numbers are numbers assigned to the location records 257, respectively, in the 1-minute range data file, and are calculated on the basis of Formula 1 given above.

As described above, in each one minute (second period) from the sampling start time (the reference point of time), the range data storage section 113a stores the upper and lower limit values of the 1-minute (second period)-based process data acquired from each of the controllers 51 to 5n as well as the second reference point of time which is the start time for the one minute (the second periods), as the 1-minute range data file 270 (the second range data), while associating the upper and lower limit values with the second reference point of time.

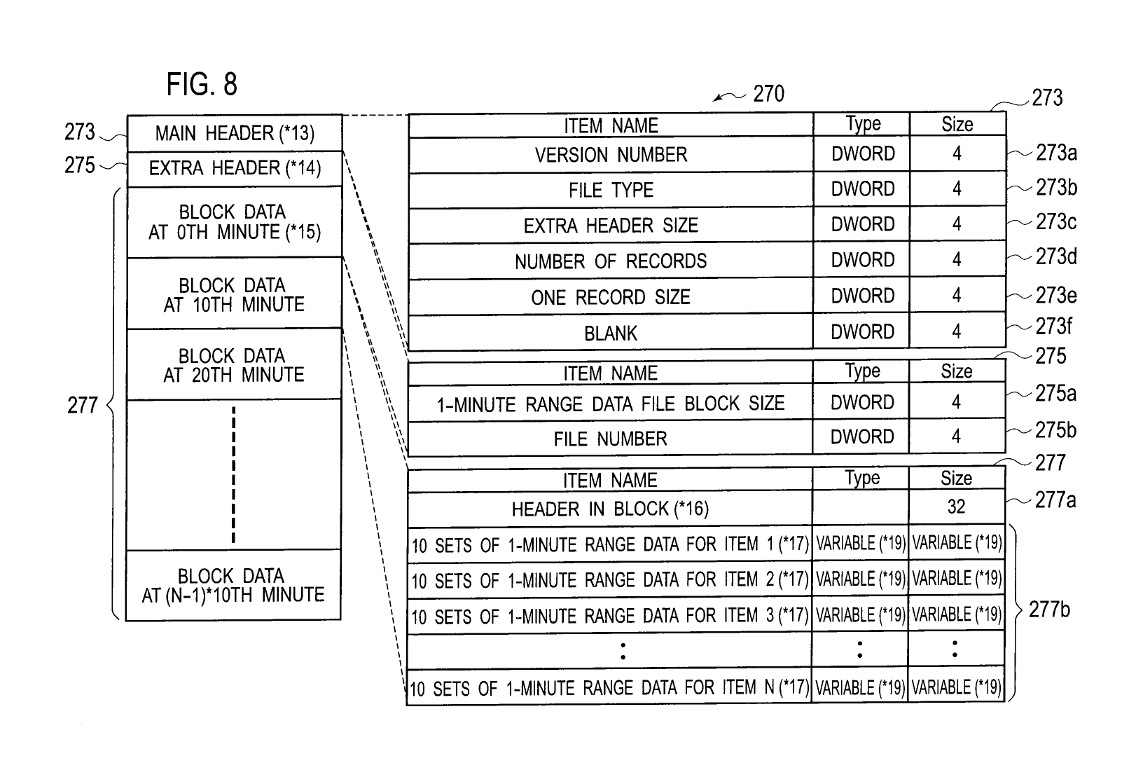

FIG. 8 is a diagram showing an example of a 1-minute range data 270 file stored in the range data storage section 113a in the storage unit 113 included in the data management apparatus 1 of the first embodiment of the present invention.

As shown in FIG. 8, the 1-minute range data file 270 includes: a main header 273 including fixed information on the 1-minute range data file; an extra header 275 including extended information on the 1-minute range data file; and block data 277 each including the upper and lower limit values of process data in the corresponding 1-minute range, and the like.

The main header 273 includes: a version number 273a which is a fixed value; a file type 273b indicating the file type of the 1-minute range data file 270; an extra header size 273c indicating the size of the extra header 275; the number of records 273d indicating the number of the location records 217; a record size 273e indicating the size of each location record 217; and a blank 273f for reserving an area for alignment.

The extra header 275 includes: a 1-minute range data file block size 275a indicating the size of a block data stored in the 1-minute range data file; and a file number 275b indicating the file number of the 1-minute range data file.

The block data 277 each include: a header-in-block 277a including fixed information on the block data 277; and 10 sets of 1-minute range data 277b, for each item number, including the upper and lower limit values in 10 sets of 1-minute range process data and the like.

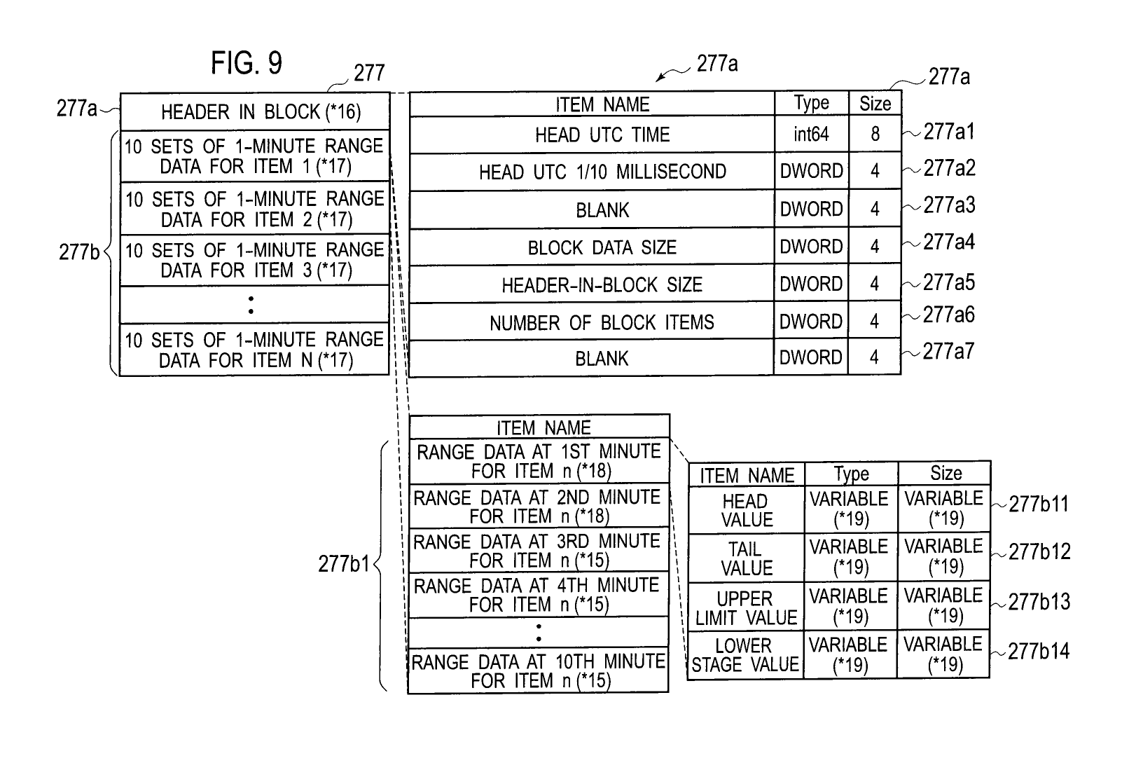

FIG. 9 is a diagram showing an example of the block data 277 on the 1-minute range data file 270 stored in the range data storage section 113a in the storage unit 113 included in the data management apparatus 1 of the first embodiment of the present invention.

As shown in FIG. 9, the header in block 277a includes: a head UTC time 277a1 indicating the time (the second reference point of time) corresponding to the head of the block data 277; a head UTC 1/10 millisecond 277a2 which is time data representing the head UTC time 277a1 in the order of 1/10 millisecond; a blank 277a3 for reserving a spare area for data storage; a block data size 277a4 indicating the size of the block data 237 excluding the size of the header-in-block 277a; a header-in-block size 277a5 indicating the size of the header-in-block 277a; the number of block items 277a6 indicating the number of the 1-minute range data 277b in the block data 277; and a blank 277a7 for reserving a spare area for data storage.

Since as described above, the block data 717 store the various 1-minute (second period)-based data acquired from each of the controllers 51 to 5n in each one minute (second period) from the sampling start time (the reference point of time), the head UTC time 277a1 included in the block data 277 at the head becomes the sampling start time (the reference point of time).

It should be noted that, if represented with accuracy in the order of 1/10 millisecond by use of the head UTC time 277a1 and the head UTC 1/10 millisecond 277b1, the time (the second reference point of time) corresponding to the head of the 1-minute range data file 250 may be used as the second reference point of time. Alternatively, only the head UTC time 277a1 may be used as the time (the second reference point of time) corresponding to the head of the 1-minute range data file 250.

Furthermore, the 10 sets of 1-minute range data 277b include sets of 1-minute range data 277b1 for each item number.

Each set of 1-minute range data 277b1 include: a head value 277b11 indicating the process data at the head of the 1-minute range data 277b1; a tail value 277b12 indicating the process data at the tail of the 1-minute range data 277b1; an upper limit value 277b13 indicating the upper limit value of the process data in a range corresponding to the 1-minute range data 277b1; and a lower limit value 277b14 indicating the lower limit value of the process data in the range corresponding to the 1-minute range data 277b1.

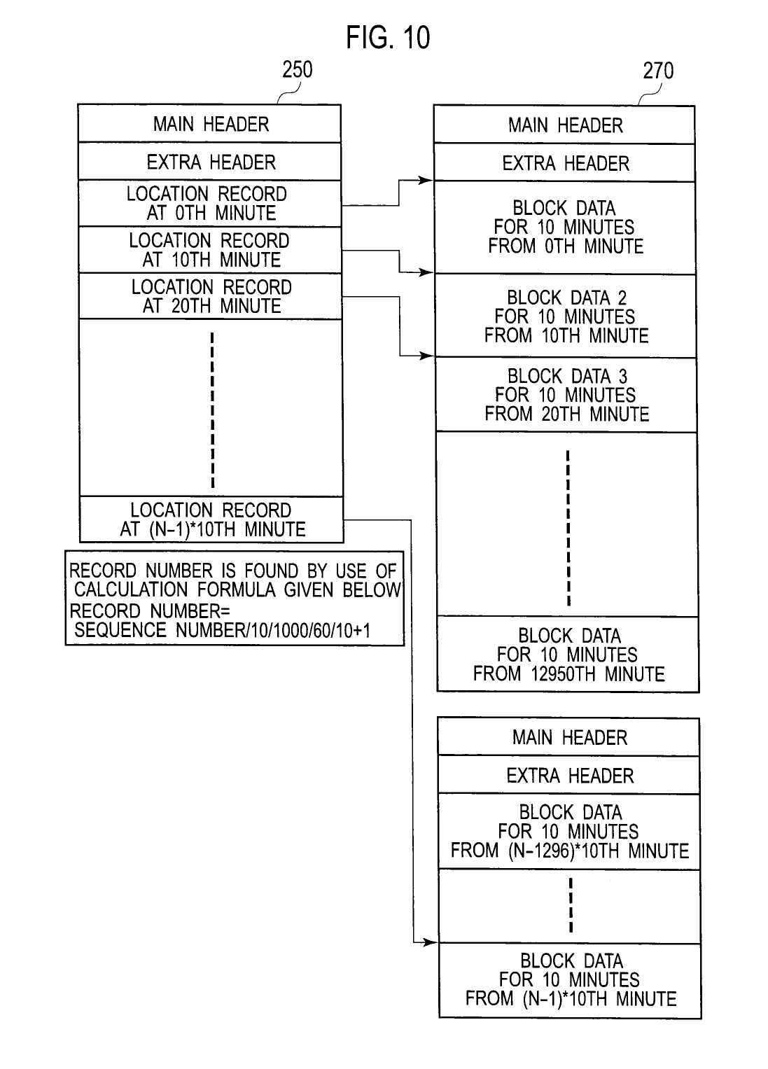

FIG. 10 is a diagram explaining a relationship between the 1-minute range data location file 250 and the 1-minute range data file 270 which are stored in the range data storage section 113a in the storage unit 113 included in the data management apparatus 1 of the first embodiment of the present invention.

As shown in FIG. 10, on the basis of the data stored in the 1-minute range data location file 250, the storage controller 111a is capable of storing data into the 1-minute range data file 270.

To put it specifically, as described above, the storage controller 111a in the CPU 111 calculates the location record numbers to be assigned to the location records 257 in the 1-minute range data file 250 by use of Formula 1. Thereby, on the basis of the calculated location record numbers, the storage controller 111a is capable of storing the block data 277 into the 1-minute range data file 270.

The sampling data storage section 113b stores the sampling data files 290.

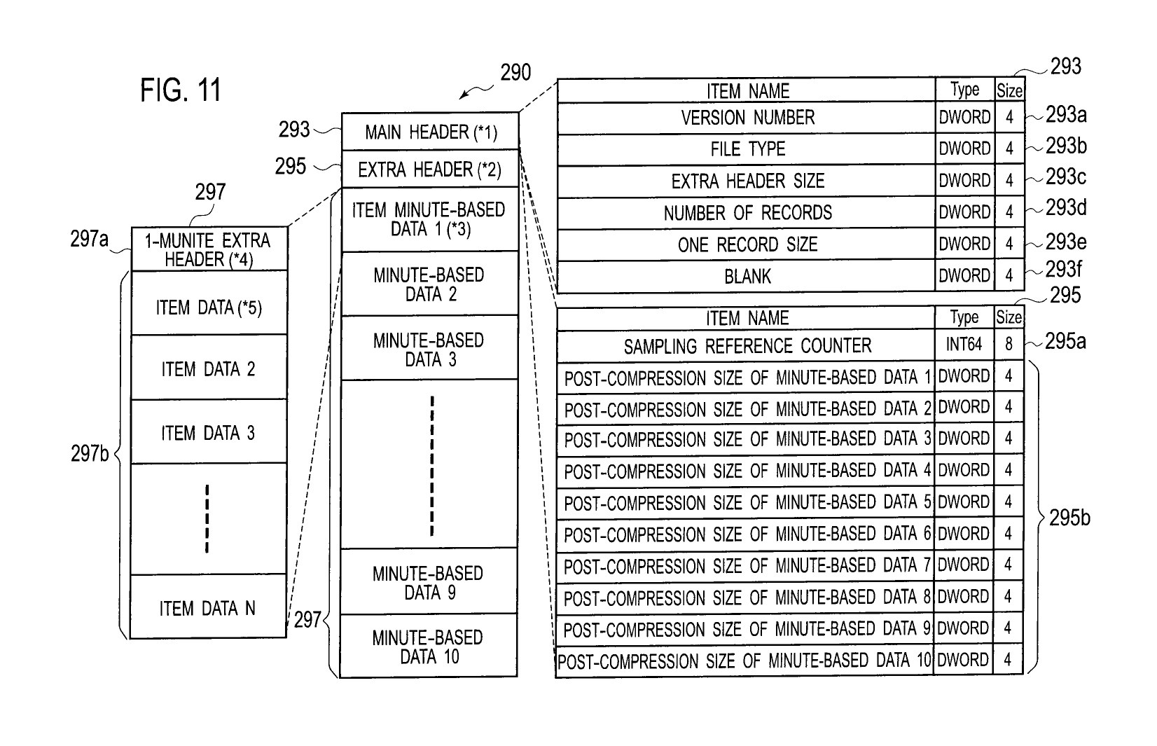

FIG. 11 is a diagram showing an example of a sampling data file 290 stored in the sampling data storage section 113b in the storage unit 113 included in the data management apparatus 1 of the first embodiment of the present invention.

As shown in FIG. 11, the sampling data file 290 includes: a main header 293 including fixed information on the sampling data file 290; an extra header 295 including extended information on the sampling data file 290; and minute-based data 297 each including process data.

The main header 293 includes: a version number 293a which is a fixed value; a file type 293b indicating the file type of the sampling data file 290; an extra header size 293c indicating the size of the extra header 295; the number of records 293d indicating the number of the minute-based data 297; a record size 293e indicating the size of the minute-based data 297; and a blank 293f for reserving an area for alignment.

The extra header 295 includes: a sampling reference counter 295a indicating a sequence number with which the sampling data file 290 for 10 minutes starts to be recorded; and post-compression sizes 295b of the respective compressed minute-based data 297.

The minute-based data 297 each include: a 1-minute extra header 297a including fixed information on the minute-based data 297; and item data 297b indicating data on the respective items.

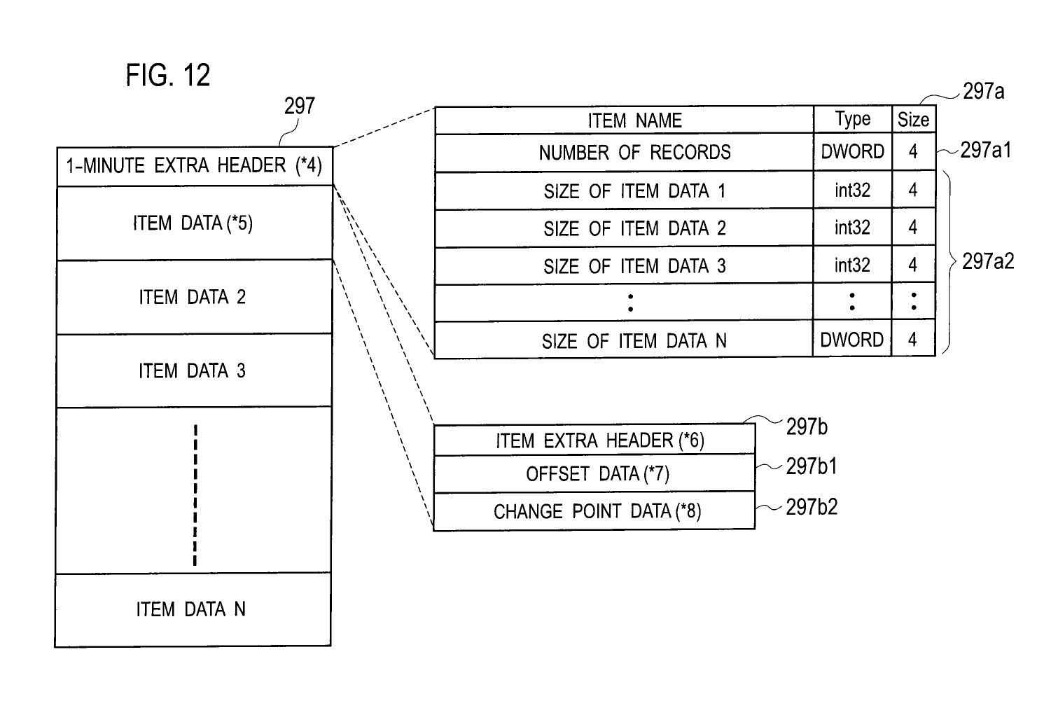

FIG. 12 is a diagram showing an example of the minute-based data 297 stored in the sampling data storage section 113b in the storage unit 113 included in the data management apparatus 1 of the first embodiment of the present invention.

As shown in FIG. 12, the minute-based data 297 include the 1-minute extra header 297a and the item data 297b.

The 1-minute extra header 297a includes: the number of records 297a1 indicating the number of the registered item data 297b; and item data sizes 297a2 indicating the sizes of the respective item data 297b.

The item data 297b each include: an item extra header 297b including fixed information on the item data 297b; offset data 297b1 indicating the elapsed time from the sampling start time (the reference point of time) through a change point of time in the process data; and change point data 297b2 indicating the process data at the change point of time in the process data.

Thereby, the sampling data storage section 113b stores the process data acquired from each of the controllers 51 to 5n and including the chronological change, as well as the elapsed time from the sampling start time (the reference point of time), as the sampling data file 290, while associating the process data with the elapsed time.

### <Operation of Data Management Apparatus 1>

Next, with reference to a flowchart, descriptions will be provided for how the data management apparatus 1 of the first embodiment of the present invention performs search processing.

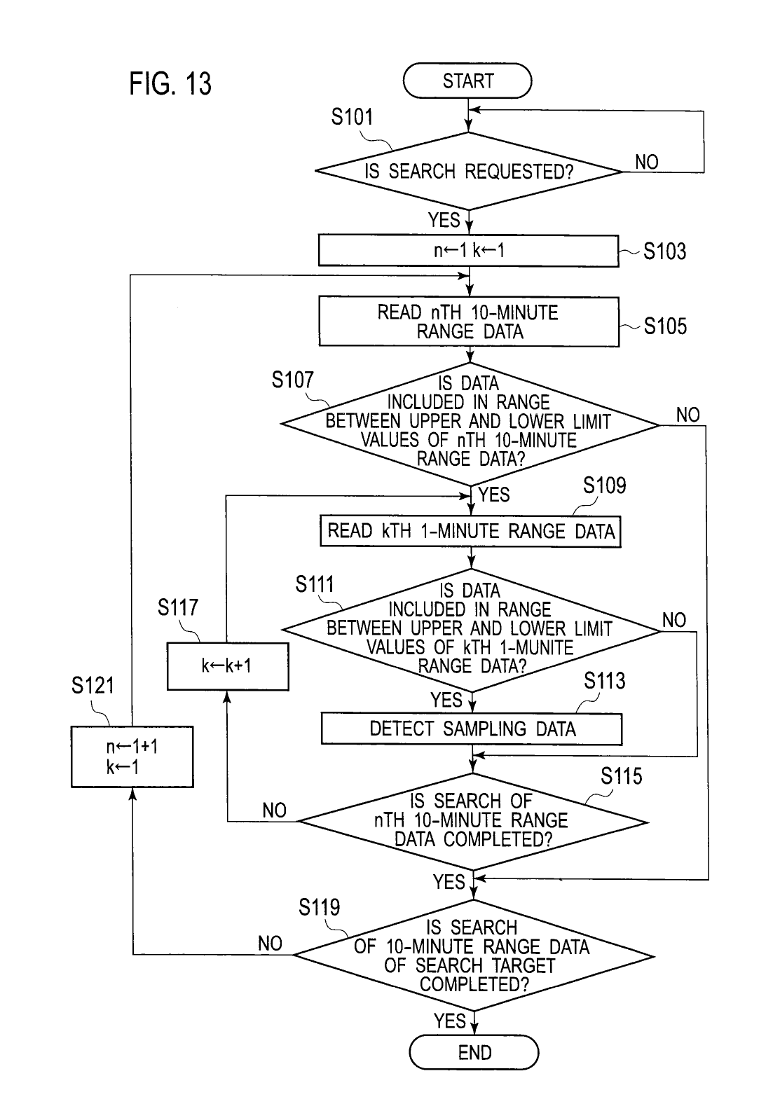

FIG. 13 is s a flowchart showing procedures of search processing performed by the data management apparatus 1 of the first embodiment of the present invention.

As shown in FIG. 13, a user requests a search by manipulating the keyboard 13, the mouse 14 and the like of the data management apparatus 1 (step S101) to begin with. Hence, the data management apparatus 1 starts the search processing. To put it specifically, if the search is requested with search conditions including a search target range (for example, from January 2012 through January 2013), an item number and a search style, the extractor 111d in the data management apparatus 1 starts the search processing.

First, the extractor 111d assigns an initial value of 1 to counters n, k (step S103).

Subsequently, the first judgment section 111b reads an nth 10-minute range data (step S105). To put it specifically, the nth 10-minute range data file 230 which falls within the search target range specified by the search conditions is read by the first judgment section 111b from the 10-minute data files 230 stored in the range data storage section 113a in the storage unit 113.

Thereafter, the first judgment section 111b judges whether or not process data are included in a range from the upper limit value to the lower limit value of the nth 10-minute range data (step S107). To put it specifically, the first judgment section 111b judges whether or not process data included in the read nth 10-minute range data and satisfying the item number and the search style included in the search conditions are included in the range from the upper limit value 237b3 to the lower limit value 237b4 of the 10-minute range data 237b.

If it is judged in step S107 that the process data are included in the range from the upper limit value to the lower limit value of the nth 10-minute range data (if YES), the second judgment section 111c reads a kth 1-minute range data (step S109). To put it specifically, of the 1-minute range data files 270 stored in the range data storage section 113a in the storage unit 113, the second judgment section 111c reads the kth 1-minute range data file 270 falling within the search target range specified by the search conditions.

Next, the second judgment section 111c judges whether or not the process data are included in a range from the upper limit value to the lower limit value of the kth 1-minute range data (step S111). To put it specifically, the second judgment section 111c judges whether or not the process data satisfying the item number and the search style included in the search conditions are included in the range from the upper limit value 277b13 and the lower limit value 277b14 of the 1-minute range data 277b1 in the read kth 1-minute range data.

If it is judged in step S111 that the process data are included in the range from the upper limit value and the lower limit value of the kth 1-minute range data (if YES), the extractor 111d extracts the sampling data (step S113). To put it specifically, the extractor 111d extracts the process data corresponding to the kth 1-minute range data from the sampling data file 290 in the sampling data storage section 113b, that is to say, the change point data satisfying the search style from the change point data 297b2 for one minute from the time indicated by the kth head UTC time 277a1. In addition, the extractor 111d extracts the extracted change point data 297b2, and the offset data 287b1 indicating the elapsed time corresponding to the extracted change point data 297b2, as the sampling data.

Subsequently, the extractor 111d judges whether or not the search of the nth 10-minute range data has been completed (step S115).

If it is judged in step S115 that the search of the nth 10-minute range data has not been completed yet (if NO), the extractor 111d increments the counter k (step S117).

On the other hand, if it is judged in step S115 that the search of the nth 10-minute range data has been completed (if YES), the extractor 111d proceeds to step S119 in the processing. The search of the 1-minute range data in the nth 10-minute range data has thus been completed.

Furthermore, if it is judged in step S115 that the search of the nth 10-minute range data has been completed (if YES), the extractor 111d judges whether or not the search of all the 10-minute range data of the search target has been completed (in step S119).

If it is judged in step S119 that the search of all the 10-minute range data of the search target has not been completed yet (if NO), the extractor 111d increments the counter n, and assigns “1” to the counter k (step S121).

On the other hand, if it is judged in step S119 that the search of all the 10-minute range data of the search target has been completed (if YES), the extractor 111d terminates the search processing. The search of all the 10-minute range data of the search target has thus been completed.

As described above, the data management apparatus 1 of the first embodiment of the present invention includes: the first judgment section 111b for judging whether or not the process data satisfying the search conditions in the search request are included in the range from the upper limit value to the lower limit value of the first range data when the search for the process data is requested; the second judgment section 111c for judging whether or not the process data satisfying the search conditions in the search request are included in the range from the upper limit value to the lower limit value of the second range data if the first judgment section 111b judges that the process data are included in the range from the upper limit value to the lower limit value of the first range data; and the extractor 111d for extracting the sampling data, inclusive of the process data satisfying the search conditions in the search request, from the sampling data storage section 113b if the second judgment section 111c judges that the process data are included in the range from the upper limit value to the lower limit value of the second range data. For this reason, the data management apparatus 1 is capable of searching the sampling data inclusive of the process data satisfying the search conditions at high speed.

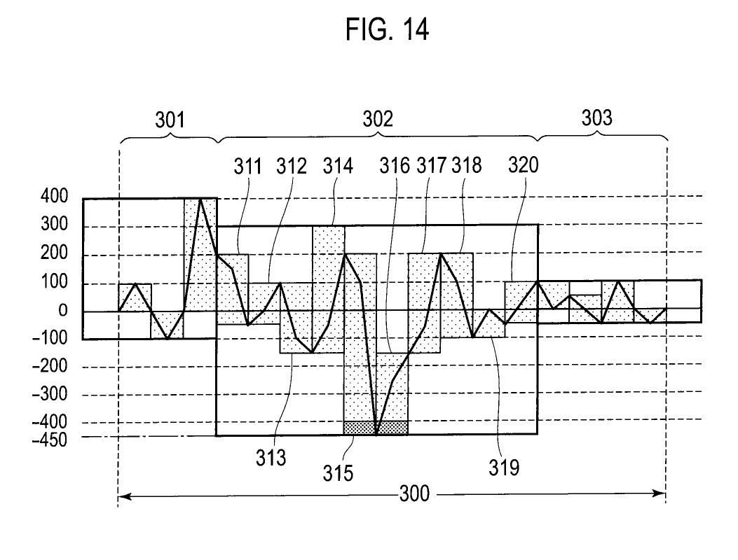

FIG. 14 is a diagram explaining how the data management apparatus 1 of the first embodiment of the present invention performs the search processing. In this respect, the descriptions will be provided citing a case where process data whose value is not greater than “−400” are extracted from process data whose item number is “1.”

As shown in FIG. 14, the first judgment section 111b reads the first 10-minute range data 301 within a search target range 300 specified by the search conditions. Subsequently, the first judgment section 111b judges whether or not process data with an item number of “1” and a value of not greater than “−400,” which are included in the search conditions, are included in the read 10-minute range data 301. In this respect, the upper and lower limit values of the 10-minute range data 301 are “400” and “−100,” respectively. For this reason, the extractor 111d judges that the 10-minute range data 301 include no process data satisfying the search conditions.

Subsequently, the first judgment section 111b reads the next 10-minute range data 302 within the search target range 300 specified by the search conditions. Thereafter, the first judgment section 111b judges whether or not process data with an item number of “1” and a value of not greater than “−400,” which are included in the search conditions, are included in the read 10-minute range data 302. In this respect, the upper and lower limit values of the 10-minute range data 302 are “300” and “−450,” respectively. For this reason, the extractor 111d judges that the 10-minute range data 302 include the process data satisfying the search conditions.

Then, the second judgment section 111c reads the first 1-minute range data 311 in the 10-minute range data 302. Thereafter, the second judgment section 111c judges whether or not the process data with the item number of “1” and the value of not greater than “−400,” which are included in the search conditions, are included in the read 1-minute range data 311. In this respect, the upper and lower limit values of the 1-minute range data 311 are “200” and “−50,” respectively. For this reason, the extractor 111d judges that the 1-minute range data 311 include no process data satisfying the search conditions.

Subsequently, the second judgment section 111c similarly judges whether or not the process data with the item number of “1” and the value of not greater than “−400,” which are included in the search conditions, are included in the 1-minute range data 312 to the 1-minute range data 320.

In the example shown in FIG. 14, the upper and lower limit values of the 1-minute range data 315 are “200” and “−450,” respectively. For this reason, the second judgment section 111c judges that the 1-minute range data 315 include the process data satisfying the search conditions.

In addition, the upper and lower limit values of the 1-minute range data 316 are “−150” and “−450,” respectively. For this reason, the second judgment section 111c judges that the 1-minute range data 316 include the process data satisfying the search conditions.

Hence, from the sampling data file 290 in the sampling data storage section 113b, the extractor 111d extracts the change point data out of the change point data 297b2 for one minute from the time indicated by the head UTC times 277a1 of each of the 1-minute range data 315, 316, and having a value of not greater than “−400.” Furthermore, the extractor 111d extracts the extracted change point data 297b2n and the offset data 287b1 indicating the elapsed time corresponding to the extracted change point data 297b2, as the sampling data.

Subsequently, the extractor 111d reads the further next 10-minute range data 303 within the search target range 300 specified by the search conditions. Thereafter, the extractor 111d judges whether or not process data with an item number of “1” and a value of not greater than “−400,” which are included in the search conditions, are included in the read 10-minute range data 303. In this respect, the upper and lower limit values of the 10-minute range data 303 are “100” and “−50,” respectively. For this reason, the extractor 111d judges that the 10-minute range data 301 include no process data satisfying the search conditions.

FIG. 14 demonstrates the example in which the search processing is performed on the single item. The number of items, however, is not limited to one.

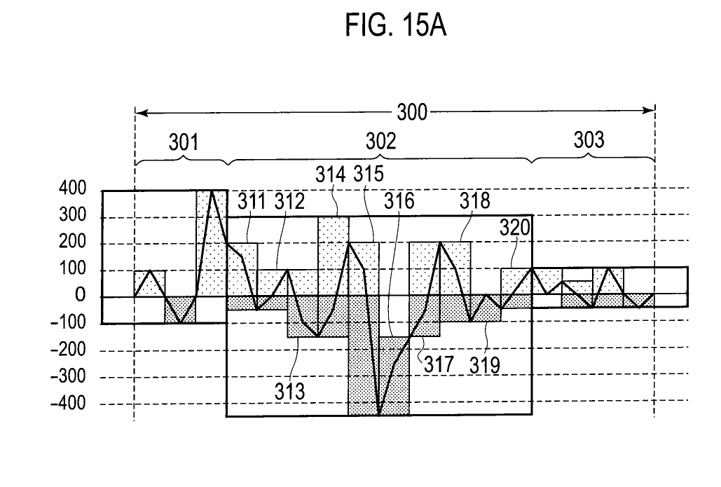

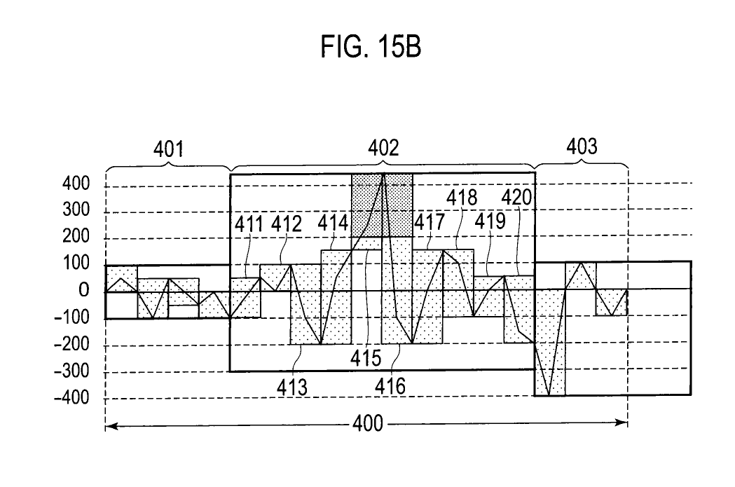

FIGS. 15A and 15B are diagrams each explaining an example of how the data management apparatus 1 of the first embodiment of the present invention performs the search processing on two items. In this respect, descriptions will be provided citing an example where: process data whose value is not greater than “0” are extracted from process data whose item number is “1”; and process data whose value is not less than “200” are extracted from process data whose item number is “2.”

As shown in FIGS. 15A and 15B, the first judgment section 111b reads the first 10-minute range data 301 within the search target range 300 specified by the search conditions. Subsequently, the first judgment section 111b judges whether or not process data with an item number of “1” and a value of not greater than “0,” which are included in the search conditions, are included in the read 10-minute range data 301. In this respect, the upper and lower limit values of the 10-minute range data 301 are “400” and “−100,” respectively. For this reason, the extractor 111d judges that the 10-minute range data 301 include the process data satisfying the search conditions.

Since the 10-minute range data 301 include the process data satisfying the search conditions, the first judgment section 111b reads the first 10-minute range data 401 within a search target range 400 specified by the search conditions. Subsequently, the first judgment section 111b judges whether or not process data with an item number of “2” and with a value of not less than “200” are included in the read 10-minute range data 401. In this respect, the upper and lower limit values of the 10-minute range data 401 are “100” and “−100,” respectively. For this reason, the first judgment section 111b judges that the 10-minute range data 301 include no process data satisfying the search conditions.

Hence, the first judgment section 111b judges that the first 10-minute range data include no process data satisfying the search conditions.

Next, the first judgment section 111b reads the next 10-minute range data 302 within the search target range 300 specified by the search conditions. Subsequently, the first judgment section 111b judges whether or not process data with an item number of “1” and a value of not greater than “0,” which are included in the search conditions, are included in the read 10-minute range data 302. In this respect, the upper and lower limit values of the 10-minute range data 302 are “300” and “−450,” respectively. For this reason, the first judgment section 111b judges that the 10-minute range data 302 include the process data satisfying the search conditions.

Since the 10-minute range data 302 include the process data satisfying the search conditions, the first judgment section 111b reads the next 10-minute range data 402 within the search target range 400 specified by the search conditions. Subsequently, the first judgment section 111b judges whether or not process data with an item number of “2” and with a value of not less than “200” are included in the read 10-minute range data 402. In this respect, the upper and lower limit values of the 10-minute range data 402 are “450” and “−200,” respectively. For this reason, the first judgment section 111b judges that the 10-minute range data 302 include the process data satisfying the search conditions.

Hence, the second judgment section 111c reads the first 1-minute range data 311 within the 10-minute range data 302, and the first 1-minute range data 411 within the 10-minute range data 402. Subsequently, the second judgment section 111c judges whether or not the process data with the item number of “1” and the value of not greater than “0,” which are included in the search conditions, are included in the read 1-minute range data 311, and whether or not the process data with the item number of “2” and the value of not less than “200,” which are included in the search conditions, are included in the read 1-minute range data 411.

In this respect, in the example shown in FIGS. 15A and 15B, the upper and lower limit values of the 1-minute range data 311 are “200” and “−50,” respectively, while the upper and lower limit values of the 1-minute range data 411 are “50” and “−100,” respectively. For this reason, the second judgment section 111c judges that neither the 1-minute range data 311 nor the 1-minute range data 411 include the process data satisfying the search conditions.

Subsequently, the second judgment section 111c similarly judges whether nor not the process data with the item number of “1” and the value of “0,” which are included in the search conditions, are included in each of the 1-minute range data 312 to the 1-minute range data 320, and whether or not the process data with the item number of “2” and the value of not less than “200,” which are included in the search conditions, are included in each of the 1-minute range data 412 to the 1-minute range data 420.

In the example shown in FIGS. 15A and 15B, the upper and lower limit values of the 1-minute range data 315 are “200” and “−450,” respectively, while the upper and lower limit values of the 1-minute range data 415 are “450” and “150,” respectively. For this reason, the second judgment section 111c judges that the 1-minute range data 315 and the 1-minute range data 415 include the process data satisfying the search conditions.

Furthermore, the upper and lower limit values of the 1-minute range data 316 are “−150” and “−450,” respectively, while the upper and lower limit values of the 1-minute range data 416 are “450” and “−200,” respectively. For this reason, the second judgment section 111c judges that the 1-minute range data 316 and the 1-minute range data 416 include the process data satisfying the search conditions.

Hence, from the sampling data file 290 in the sampling data storage section 113b, the extractor 111d extracts the change point data out of the change point data 297b2 for one minute from the time indicated by each of the head UTC times 277a1 of the 1-minute range data 315, 316, 415 and 416, as well as having a value of not greater than “0” under Item 1 and a value of not less than “200” under Item 2. Furthermore, the extractor 111d extracts the extracted change point data 297b2n and the offset data 287b1 indicating the elapsed time corresponding to the extracted change point data 297b2, as the sampling data.

As described above, the data management apparatus 1 of the first embodiment of the present invention includes: the first range data storage section 21 for storing as the first range data the upper and lower limit values of process data acquired from each of the controllers 51 to 5n in each first period from the reference point of time, and the first reference point of time which is the start time for the first period, while associating the upper and lower limit values with the first reference point of time; the second range data storage section 22 for storing as the second range data the upper and lower limit values of the process data acquired from each of the controllers 51 to 5n in each second period shorter than the first period from the reference point of time; the sampling data storage section 113b for storing as the sampling data the process data acquired from each of the controllers 51 to 5n and including the chronological change, as well as the elapsed time from the reference point of time, while associating the process data with the elapsed time; and the storage controller 111b for, on the basis of the process data acquired from each of the controllers 51 to 5n, generating the first range data and storing the generated first range data into the first range data storage section 21 in each first period, generating the second range data and storing the generated second range data into the second range data storage section 22 in each second period, as well as generating the sampling data and storing the generated sampling data into the sampling data storage section 113b in each second period. For this reason, the data management apparatus 1 is capable of: storing a large amount of process data into a relatively small storage area; and, searching the stored process data at high speed.

### EXPLANATION OF REFERENCE SIGNS

1 data management apparatus
8 control network
11 apparatus main body
12 monitor
13 keyboard
14 mouse
21 first range data storage section
22 second range data storage section
51 to 5n controller
61 to 6p monitoring target
111 CPU
111a storage controller
111b first judgment section
111c second judgment section
111d extractor
112 memory
113 storage unit
113a range data storage section
113b sampling data storage section

### INDUSTRIAL APPLICABILITY

The present invention is applicable to an online data management system for monitoring a plant, and the like.

1. A data management apparatus comprising:
a first range data storage section configured to store, as first range data, an upper limit value and a lower limit value of process data acquired from a monitoring target in each first period from a reference point of time, and a first reference point of time which is a start time for the first period, while associating the upper and lower limit values with the first reference point of time;
a second range data storage section configured to store, as second range data, an upper limit value and a lower limit value of the process data acquired from the monitoring target in each second period from the reference point of time, the second period being shorter than the first period, and a second reference point of time which is a start time for the second period, while associating the upper and lower limit values with the second reference point of time;
a sampling data storage section configured to store, as sampling data, the process data acquired from the monitoring target and including a chronological change, and an elapsed time from the reference point of time, while associating the process data with the elapsed time; and
a storage controller configured, on the basis of the process data acquired from the monitoring target,
to generate the first range data and to store the generated first range data into the first range data storage section in each first period,
to generate the second range data and to store the generated second range data into the second range data storage section in each second period, and
to generate the sampling data and to store the generated sampling data into the sampling data storage section in each second period.

2. The data management apparatus of claim 1 further comprising:
a first judgment section configured, when a search for the process data is requested, to judge whether or not process data satisfying a search condition in the search request is included in a range from the upper limit value to the lower limit value of the first range data;
a second judgment section configured to judge whether or not the process data satisfying the search condition in the search request is included in a range from the upper limit value to the lower limit value of the second range data if the first judgment section judges that the process data is included in the range from the upper limit value to the lower limit value of the first range data; and
an extractor configured to extract the sampling data including the process data satisfying the search condition in the search request from the sampling data storage section if the second judgment section judges that the process data is included in the range from the upper limit value to the lower limit value of the second range data.

3. A data management method comprising:
a first range data storage step of storing, as first range data, an upper limit value and a lower limit value of process data acquired from a monitoring target in each first period from a reference point of time, and a first reference point of time which is a start time for the first period, into a first range data storage section while associating the upper and lower limit values with the first reference point of time;
a second range data storage step of storing, as second range data, an upper limit value and a lower limit value of the process data acquired from the monitoring target in each second period from the reference point of time, the second period being shorter than the first period, and a second reference point of time which is a start time for the second period, into a second range data storage section while associating the upper and lower limit values with the second reference point of time; and
a sampling data storage step of storing, as sampling data, the process data acquired from the monitoring target and including a chronological change, and an elapsed time from the reference point of time, into a sampling data storage section while associating the process data with the elapsed time.

4. The data management method of claim 3 further comprising:
a first judgment step of, when a search for the process data is requested, judging whether or not process data satisfying a search condition in the search request is included in a range from the upper limit value to the lower limit value of the first range data;
a second judgment step of judging whether or not the process data satisfying the search condition in the search request is included in a range from the upper limit value to the lower limit value of the second range data if it is judged in the first judgment step that the process data is included in the range from the upper limit value to the lower limit value of the first range data; and
an extraction step of extracting the sampling data including the process data satisfying the search condition in the search request from the sampling data storage section if it is judged in the second judgment step that the process data is included in the range from the upper limit value to the lower limit value of the second range data.

5. A data management program causing a computer to execute:
a first range data storage step of storing, as first range data, an upper limit value and a lower limit value of process data acquired from a monitoring target in each first period from a reference point of time, and a first reference point of time which is a start time for the first period, into a first range data storage section while associating the upper and lower limit values with the first reference point of time;
a second range data storage step of storing, as second range data, an upper limit value and a lower limit value of the process data acquired from the monitoring target in each second period from the reference point of time, the second period being shorter than the first period, and a second reference point of time which is a start time for the second period, into a second range data storage section while associating the upper and lower limit values with the second reference point of time; and
a sampling data storage step of storing, as sampling data, the process data acquired from the monitoring target and including a chronological change, and an elapsed time from the reference point of time, into a sampling data storage section while associating the process data with the elapsed time.

6. The data management program of claim 5 causing the computer to further execute:
a first judgment step of, when a search for the process data is requested, judging whether or not process data satisfying a search condition in the search request is included in a range from the upper limit value to the lower limit value of the first range data;
a second judgment step of judging whether or not the process data satisfying the search condition in the search request is included in a range from the upper limit value to the lower limit value of the second range data if it is judged in the first judgment step that the process data is included in the range from the upper limit value to the lower limit value of the first range data; and
an extraction step of extracting the sampling data including the process data satisfying the search condition in the search request from the sampling data storage section if it is judged in the second judgment step that the process data is included in the range from the upper limit value to the lower limit value of the second range data.
